(19) United States
(12) Patent Application Publication
(10) Pub. No.: US 2025/0371997 A1
(43) Pub. Date: Dec. 4, 2025

(54) METHOD OF IMPROVING LANGUAGE FLUENCY AND OR AIDING MUSICAL INSTRUCTION

(71) Applicant: Richard MAZEL, Piedmont, CA (US)

(72) Inventor: Richard MAZEL, Piedmont, CA (US)

(21) Appl. No.: 19/221,800

(22) Filed: May 29, 2025

Related U.S. Application Data
(60) Provisional application No. 63/654,506, filed on May 31, 2024.

(51) Int. Cl. G09B 19/06; G06F 40/205; G10G 1/00

(52) U.S. Cl. CPC G09B 19/06; G06F 40/205; G10G 1/00

(57) ABSTRACT

The present disclosure provides a method and system for adapting music having lyrics and musical notes into a visual output of parsed words and corresponding musical notes, wherein the visual output shows characteristics of the words within the lyrics, as well as correlates the words with the alignment of their corresponding musical notes in relative position as they would appear on a musical staff.

### CROSS-REFERENCE TO RELATED APPLICATION

This application claims the benefit of U.S. Provisional Application No. 63/654,506, filed May 31, 2024, which is hereby incorporated by reference in its entirety into the present application.

### BACKGROUND

Various linguistic methods can be used to teach a foreign language. However, the ability to read and understand words of a foreign language does not necessarily translate into the ability to speak in phrases, clauses, full sentences and paragraphs, much less be fluent in conversation.

A method of deconstructing sentences in an enjoyable manner would be useful in advancing language fluency, such that words of a learned sentence can be recycled to create new sentences. Specifically, combining sentence deconstruction with music would provide a further enhancement to the process of improving fluency. However, lack of knowledge about how to read music can impede the processes of improving language fluency and/or learning to sing.

### SUMMARY

The following brief summary is not intended to include all features and aspects of the present disclosure, nor does it imply that the disclosure must include all features and aspects discussed in this summary.

The present disclosure provides a method and system for improving language fluency through song, by transcribing musical notes into an original musical notation system. The present method and system adapts music having lyrics and musical notes into a visual output of parsed words and corresponding musical notes, wherein the visual output shows characteristics of the words within the lyrics, as well as correlates the words with the alignment of their corresponding musical notes in relative position as they would appear on a musical staff.

The present disclosure likewise provides a method and system for aiding music instruction by transcribing musical notes into an original musical notation system. A method of deconstructing sentences in language combined with a novel system of depicting musical information can aid beginning musicians and/or singers in learning to play or sing songs in an enjoyable manner. Specifically, a unique method of combining sentence deconstruction with musical note variation of defined pitch and duration provides a further enhancement to teaching music and/or singing, serving as a bridge to the introduction of musical notation for beginning musicians and/or chorus members.

The foregoing and other objects, features and advantages of the disclosure will be apparent from the following more particular description of embodiments of the disclosure, as illustrated in the accompanying drawings in which like reference characters refer to the same parts throughout the different views. The drawings are not necessarily to scale, emphasis instead being placed upon illustrating the principles of the disclosure.

### BRIEF DESCRIPTION OF THE DRAWINGS

FIG. 1 shows components useful in for transcribing musical notes into an original musical notation system.

FIG. 2 is a flow chart showing how a song and/or musical score can be transformed into a Bubble File and optionally further transformed into a document for viewing or printing.

FIG. 3 shows how a portion of “Ode to Joy” by Ludwig van Beethoven might be seen on a traditional karaoke screen.

FIG. 4 shows how a portion of the musical score and lyrics to “Ode to Joy” would appear as a typical musical score.

FIG. 5 shows how the method and system of the disclosure would transform “Ode to Joy” into the output of the present method and system, in one embodiment termed a “BubbleSong™.”

FIG. 6 shows how the present method can also be used to depict precisely how an artist chooses to sing a song.

FIG. 7 shows how the present method can be used with languages that are read right to left.

### DETAILED DESCRIPTION

Unless defined otherwise, all technical and scientific terms used herein have the same meaning as commonly understood by those of ordinary skill in the art to which this disclosure belongs. Although any methods and materials similar or equivalent to those described herein can be used in the practice or testing of the present disclosure, the preferred methods and materials are described. Generally, nomenclatures are those well-known and commonly used in the art. Certain experimental techniques, not specifically defined, are generally performed according to conventional methods well known in the art.

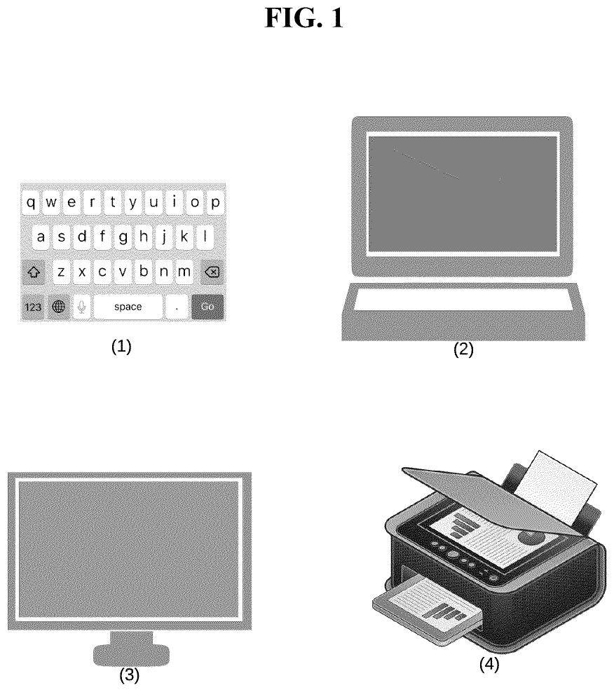

The disclosure provides a method and system for transcribing musical notes into an original musical notation system. In one embodiment, the method, system and output are termed BUBBLE SONG™. The method may use a conventional computer keyboard (1) or laptop keyboard (2) for inputting and processing the musical note data, the computer (1) (or laptop (2)) having a conventional screen (3) and/or printer (4) for displaying the BubbleSong™M output. See, FIG. 1.

The method breaks down songs into sung words and phrases in which the syllables of the words are arranged and depicted in a way that mirrors musical notation. In brief, shorter notes are depicted in darker lettering, mirroring for example quarter notes, eighth notes and others, while longer notes are depicted as white lettering, mirroring half notes, whole notes and others. In addition, smaller letters represent shorter notes, while larger letters, longer notes. In one case, notes were derived from published written music for popular songs. In another version, BubbleSong™ is derived from the actual performed notes of a skilled artist. This more detailed transcription produces a more nuanced BubbleSong™ musical depiction.

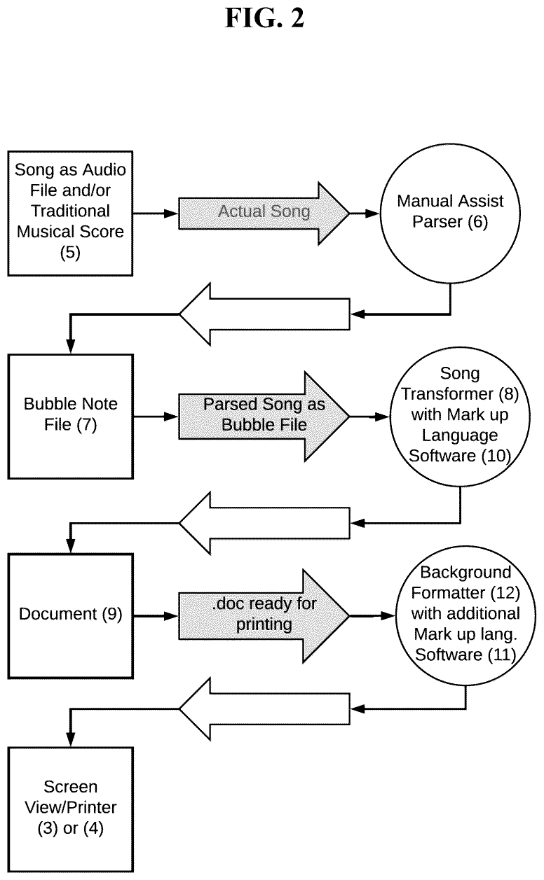

The method and system (FIG. 2) take a file of song lyrics (5) and parse them with musical notes, in one embodiment using a conventional computer keyboard (1), via a Manual Assist Parser (6). This new Bubble Note File (7) is then transformed by the Song Transformer (8) into a BubbleSong™ Version Document (9) of the notes and lyrics. A markup language software program (10) creates the basic BubbleSong™ Document (9). Additional markup software (11) for the Background Formatter (12) is employed to place background images, clip art, drawings and/or videos to accompany the output.

In one embodiment, the method and system can be used in conjunction with applications already on the market that convert instrumental and vocal music to notes on a musical score.

The method produces a product with can optionally be experienced via karaoke, that makes learning the melody of a song effortless and esthetic, can assist a person with a challenge or learning disability learn a new piece of music, or can transform a favorite song into treasured personal memory.

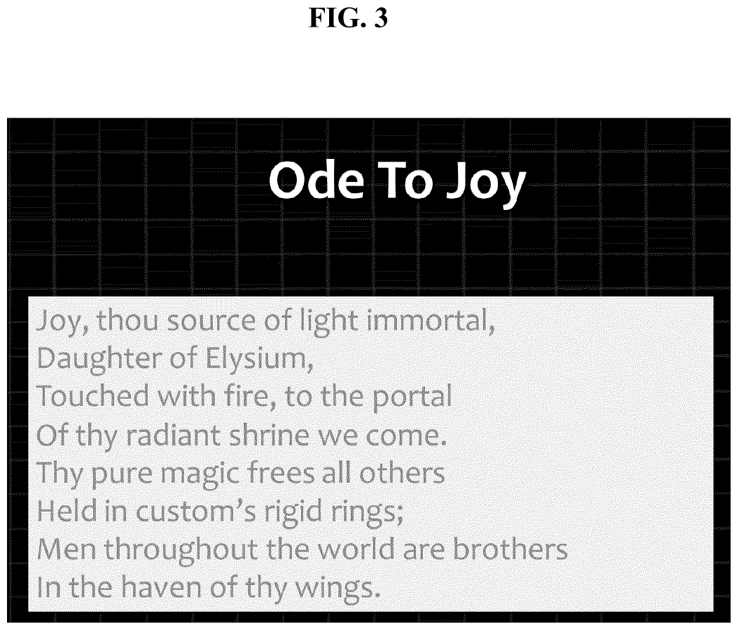

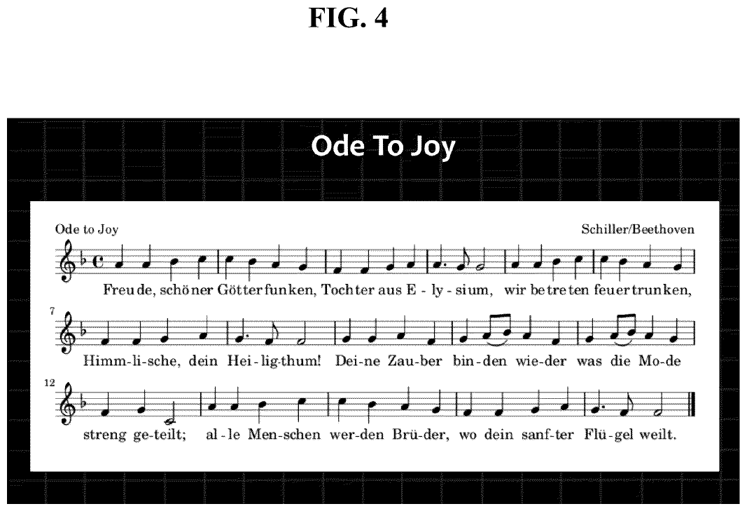

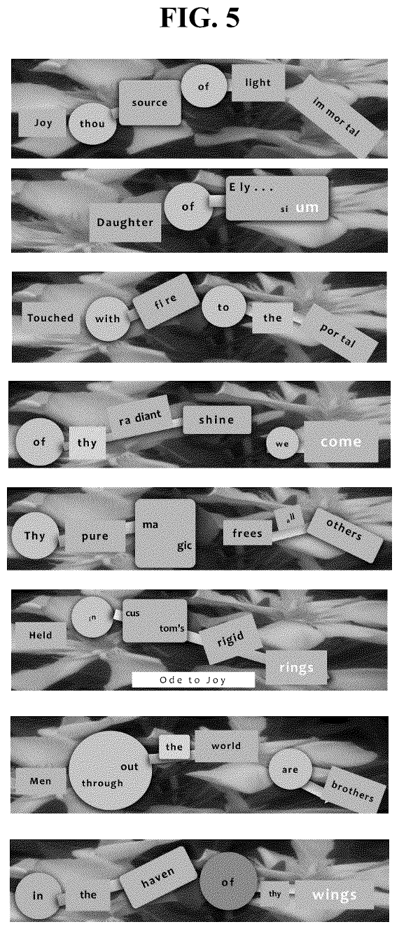

The output of the system deconstructs language so that it can be immediately recycled to create new sentences and assist a student of a foreign language in improving fluency. When combined with song, the output can follow the ups and downs of the musical scale while containing within it the lyrics of the song. See, FIGS. 3-5.

The output of the system can be used to highlight phrases. The relative pitch is represented by height, and the relative note length is indicated by the font size and black or white color, and wherever possible, the size of the box containing the word, i.e., the “word container.”

Stronger colors for the “word containers” are used to content words (i.e., words that carry the most meaning, such as nouns, adjectives and action verbs.) In English, content words tend to be pronounced relatively more forte. Lighter colors are used for the “word containers” around function words (i.e. words that have grammatical or structural functions such as articles, prepositions, and conjunctions), which in English tend to be pronounced relatively more piano.

Quarter, eighth and sixteenth notes are represented with progressively smaller fonts to emphasize that they are sung faster. Similarly, half notes and whole notes are in a somewhat larger font to emphasize that they are sung longer. Also, smaller words or syllables are spread out visually for longer notes.

In musical notation, a dot after a note lengthens it. With the present method and system, when a whole note is lengthened, three dots after it will indicate to extend the word half as long on that note. When the three dots are spaced more, it will mean to lengthen the duration of the note more than half as long.

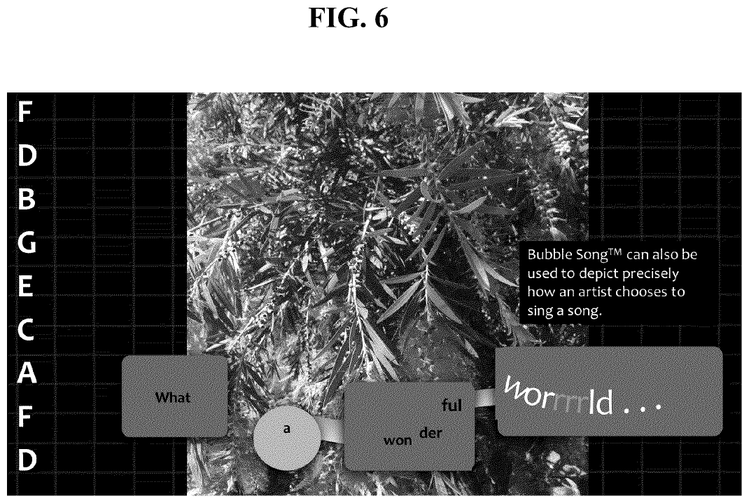

The method can also produce an output that depicts precisely how a particular artist chooses to sing a song. See, FIG. 6.

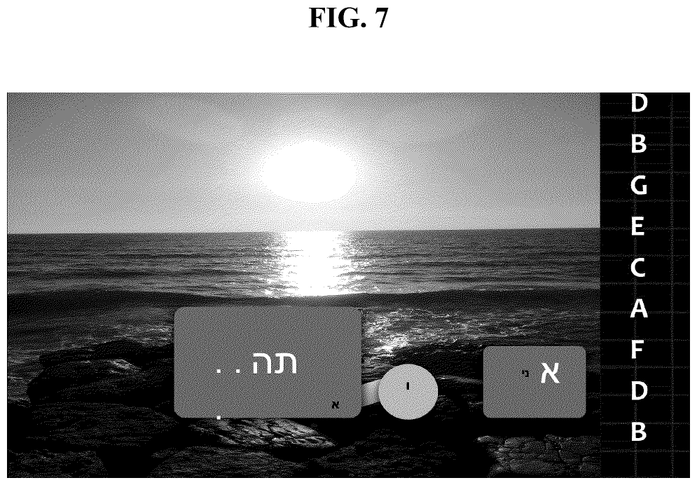

The present method can be used with languages that are written left to right, and also those written right to left (e.g., Hebrew, Arabic, Farsi, and sometimes Korean, Chinese, Japanese and others.) The present method ensures that a word is aligned with its pitch. See, FIG. 7.

The present method and system can be used with or without karaoke, in print or via a computer interface.

In yet more detail, the present disclosure is described by the following items which represent preferred embodiments thereof.
1. The method for parsing song lyrics with musical notes, comprising:
   a. providing to a processor a file of song lyrics and corresponding musical score;
   b. utilizing a manual assist parser system to produce a file in which separate words of the lyrics are placed in separate visual containers;
      i. wherein the visual containers are modified to indicate features of words in the lyrics; and
      ii. wherein the visual containers are placed in relative position according to musical notes to which they correspond; and
   c. transforming the file into an output file in which the words of the lyrics are parsed with their corresponding musical notes.
2. The method of item 1, wherein the parsing assists an individual in language fluency.
3. The method of item 1, wherein the parsing assists an individual in learning a new piece of music.
4. The method of item 1, wherein the parsing transforms a favorite song into a treasured personal memory.
5. The method of item 1, further comprising using a background formatter to add background images, clip art, drawings and/or videos to the output file.
6. The method of item 1, wherein the visual output is a document.
7. The method of item 1, wherein the visual output is visualized on a monitor or computer screen.
8. A system for parsing song lyrics with musical notes, comprising:
   a. a processor that processes a file of song lyrics and corresponding musical score;
   b. a manual assist parser system that produces a file in which separate words of the lyrics are placed in separate visual containers;
      i. wherein the visual containers are modified to indicate features of words in the lyrics; and
      ii. wherein the visual containers are placed in relative position according to musical notes to which they correspond;
   c. a transformer to transform the file into an output file in which the words of the lyrics are parsed with their corresponding musical notes.
   d. The system of item 8, further comprising a background formatter to add background images, clip art, drawings and/or videos to the output file.
9. An output of the system of item 8 comprising a file in which separate words of the lyrics are placed in separate visual containers, wherein the visual containers are modified to indicate features of words in the lyrics, wherein the visual containers are placed in relative position according to musical notes to which they correspond, and the words of the lyrics are parsed with their corresponding musical notes.

Various changes and modifications to the disclosed embodiments will be apparent to those skilled in the art and such changes and modifications including, without limitation, those relating to the systems and/or methods of the disclosure may be made without departing from the spirit of the disclosure and the scope of the appended claims.

While this disclosure has been particularly shown and described with references to embodiments thereof, it will be understood by those skilled in the art that various changes in form and details may be made therein without departing from the scope of the disclosure encompassed by the appended claims.

1. The method for parsing song lyrics with musical notes, comprising:
a. providing to a processor a file of song lyrics and corresponding musical score;
b. utilizing a manual assist parser system to produce a file in which separate words of the lyrics are placed in separate visual containers;
i. wherein the visual containers are modified to indicate features of words in the lyrics; and
ii. wherein the visual containers are placed in relative position according to musical notes to which they correspond; and
c. transforming the file into an output file in which the words of the lyrics are parsed with their corresponding musical notes.

2. The method of claim 1, wherein the parsing assists an individual in language fluency.

3. The method of claim 1, wherein the parsing assists an individual in learning a new piece of music.

4. The method of claim 1, wherein the parsing transforms a favorite song into a treasured personal memory.

5. The method of claim 1, further comprising using a background formatter to add background images, clip art, drawings and/or videos to the output file.

6. The method of claim 1, wherein the visual output is a document.

7. The method of claim 1, wherein the visual output is visualized on a monitor or computer screen.

8. A system for parsing song lyrics with musical notes, comprising:
a. a processor that processes a file of song lyrics and corresponding musical score;
b. a manual assist parser system that produces a file in which separate words of the lyrics are placed in separate visual containers;
i. wherein the visual containers are modified to indicate features of words in the lyrics; and
ii. wherein the visual containers are placed in relative position according to musical notes to which they correspond;
c. a transformer to transform the file into an output file in which the words of the lyrics are parsed with their corresponding musical notes.

9. The system of claim 8, further comprising a background formatter to add background images, clip art, drawings and/or videos to the output file.

10. An output of the system of claim 8 comprising a file in which separate words of the lyrics are placed in separate visual containers, wherein the visual containers are modified to indicate features of words in the lyrics, wherein the visual containers are placed in relative position according to musical notes to which they correspond, and the words of the lyrics are parsed with their corresponding musical notes.
